(19) United States
(12) Patent Application Publication
(10) Pub. No.: US 2010/0014431 A1
(43) Pub. Date: Jan. 21, 2010

(54) METHOD AND APPARATUS FOR PROVIDING AUTOMATED PROCESSING OF A NETWORK SERVICE ALARM

(76) Inventors: Paritosh Bajpay, Edison, NJ (US); Roberta Bienfait, Norcross, GA (US); Mojgan Dardashti, Holmdel, NJ (US); Jackson Liu, Middletown, NJ (US); Zhiqiang Qian, Holmdel, NJ (US); Brian Talmadge, Plainfield, NJ (US); Michael John Zinnikas, North Brunswick, NJ (US)

Correspondence Address: AT & T LEGAL DEPARTMENT - WT, PATENT DOCKETING, ROOM 2A-207, ONE AT& T WAY, BEDMINSTER, NJ, 07921, US

(21) Appl. No.: 12/175,167

(22) Filed: Jul. 17, 2008

(51) Int. Cl. H04J 3/14

(52) U.S. Cl. 370/242

(57) ABSTRACT

A method and apparatus for providing automatic processing of a software defined network alarm or an integrated services digital network alarm are disclosed. For example, the method receives a trouble ticket for an SDN service or an ISDN service, and retrieves at least one of: a calling to number, a calling from number, one or more facility identifiers associated one or more facilities, or one or more channel identifiers related to the trouble ticket. The method then retrieves data for one or more network outages for the one or more facilities.

The present invention relates generally to communication networks and, more particularly, to a method and apparatus for providing automated processing of a network service alarm, e.g., a software defined network alarm or an integrated services digital network voice service alarm on a switched and/or Internet Protocol (IP) network.

### BACKGROUND OF THE INVENTION

A customer may subscribe to a software defined network and/or integrated services digital network voice service. When a service failure or degradation occurs, it may be detected by the network service provider or reported by a customer to the network service provider. For example, if a customer detects a failure on his/her software defined network, the customer may report a trouble on a circuit Identification (circuit ID) assigned for the service. The network service provider may then dispatch maintenance personnel to perform trouble isolation and repair. However, if the called number is an Internet Protocol (IP) telephone number, maintenance personnel has to isolate the trouble manually. In a large network, the cost of dispatching personnel for each detected and/or reported problem is very expensive. In addition, the customer may be receiving a degraded service during the repair. The degraded service and/or delay in performing maintenance will further affect customer satisfaction.

### SUMMARY OF THE INVENTION

In one embodiment, the present invention discloses a method and apparatus for providing automatic processing of a software defined network alarm or an integrated services digital network alarm. For example, the method receives a trouble ticket for an SDN service or an ISDN service, and retrieves at least one of: a calling to number, a calling from number, one or more facility identifiers associated one or more facilities, or one or more channel identifiers related to the trouble ticket. The method then retrieves data for one or more network outages for the one or more facilities.

### BRIEF DESCRIPTION OF THE DRAWINGS

The teaching of the present invention can be readily understood by considering the following detailed description in conjunction with the accompanying drawings, in which:

FIG. 1 illustrates an exemplary network related to the present invention;

FIG. 2 illustrates an exemplary network with automated processing of a software defined network and/or an integrated services digital network voice alarm;

FIG. 3 illustrates a flowchart of a method for providing automated processing of a software defined network and/or an integrated services digital network voice alarm;

FIG. 4 illustrates a flowchart of a method for identifying and reporting troubles related to network outages;

FIG. 5 illustrates a flowchart of a method for determining the status of all trunks for an SDN or ISDN service and notifying a work center; and

FIG. 6 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present invention broadly discloses a method and apparatus for providing automated processing of a network service alarm, e.g., a software defined network alarm, or an integrated services digital network voice alarm on a switched and/or Internet Protocol (IP) network.

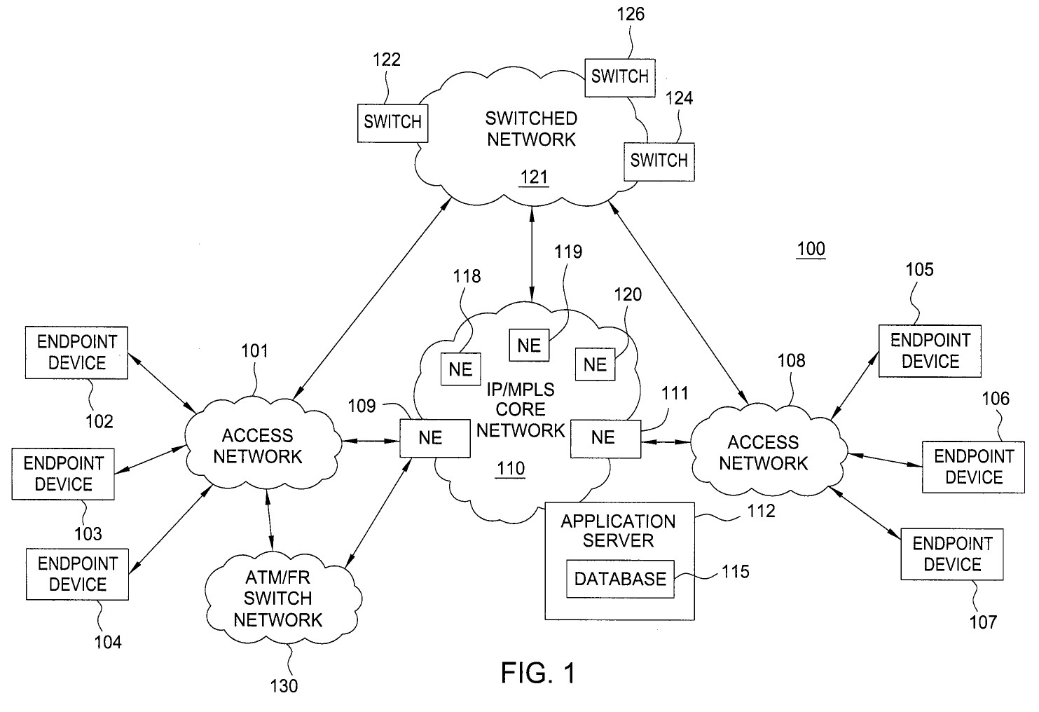

FIG. 1 is a block diagram depicting an exemplary network 100 related to the current invention. Exemplary networks include switched networks, Internet protocol (IP) networks, Asynchronous Transfer Mode (ATM) networks, frame-relay networks, and the like.

A switched network is broadly defined as a network that creates continuous pathways between callers and called parties by disconnecting and reconnecting lines in various configurations (i.e. by switching). ATM, frame-relay and IP networks, etc. are packet based networks. An IP network is broadly defined as a network that uses Internet Protocol such as IPv4 or IPv6 and the like, to exchange data packets.

In one embodiment, the network 100 may comprise a plurality of endpoint devices 102-104 configured for communication with the core packet network 110 (e.g., an IP based core backbone network supported by a service provider) or the switched network 121. The endpoint devices 102-104 may communicate with the switched network 121 and/or the IP/MPLS core network 110 via an access network 101. Similarly, a plurality of endpoint devices 105-107 are configured for communication with the core packet network 110 and/or the switched network 121 via an access network 108. The switched network 121 and the IP/MPLS core network 110 are connected to enable calls to originate in either network and complete in either network seamlessly. For example, a Gigabit switched router in the IP network may be connected to an edge switch in the switched network.

The network elements 109 and 111 may serve as gateway servers or edge routers for the IP/MPLS core network 110. Switches 122-124 may serve as switches or edge switches for the switched network 121.

The endpoint devices 102-107 may comprise customer endpoint devices such as personal computers, laptop computers, Personal Digital Assistants (PDAs), servers, routers, and the like. The access networks 101 and 108 serve as a means to establish a connection between the “endpoint devices 102-107” and “one or more of the NEs 109 and 111, and the switches 122-124.” The access networks 101 and 108 may each comprise a Digital Subscriber Line (DSL) network, a broadband cable access network, a Local Area Network (LAN), a Wireless Access Network (WAN), a 3^{rd} party network, and the like.

The access networks 101 and 108 may be either directly connected to NEs 109 and 111 of the IP/MPLS core network 110 or through an Asynchronous Transfer Mode (ATM) and/or Frame Relay (FR) switch network 130. If the connection to the IP/MPLS core network 110 is through the ATM/FR network 130, the packets from customer endpoint devices 102-104 (traveling towards the IP/MPLS core network 110) traverse the access network 101 and the ATM/FR switch network 130 and reach the border element 109.

The ATM/FR network 130 contains Layer 2 switches functioning as Provider Edge Routers (PER) and/or Provider Routers (PR). The PERs may also contain an additional Route Processing Module (RPM) that converts Layer 2 frames to Layer 3 Internet Protocol (IP) frames. An RPM enables the transfer of packets from a Layer 2 Permanent Virtual Connection (PVC) circuit to an IP network which is connectionless.

Some NEs (e.g., NEs 109 and 111) reside at the edge of the IP/MPLS core infrastructure and interface with customer endpoints over various types of access networks. An NE that resides at the edge of a core infrastructure is typically implemented as an edge router, a media gateway, a border element, a firewall, a switch, and the like. An NE may also reside within the IP network (e.g., NEs 118-120) and may be used as a mail server, honeypot, a router, or like device. The IP/MPLS core network 110 also comprises an application server 112 that contains a database 115. The application server 112 may comprise any server or computer that is well known in the art, and the database 115 may be any type of electronic collection of data that is also well known in the art. Those skilled in the art will realize that although only six endpoint devices, two access networks, five network elements, and one application server are depicted in FIG. 1, the communication system 100 may be expanded by including additional endpoint devices, access networks, network elements, 3^{rd} party networks, application servers, and the like without altering the present invention.

The above IP network is described to provide an illustrative environment in which packets for voice and data services are transmitted on switched and/or IP networks. An enterprise customer may subscribe to a software defined network and/or integrated services digital network service. In one embodiment, the enterprise customer may detect a failure/alarm and reports the failure/alarm to the service provider on a circuit ID dedicated for said service. For example, the enterprise customer may interact with an Interactive Voice Response (IVR) system and reports an outage/degradation for a circuit ID. In one embodiment, the present invention discloses a method and apparatus for providing automatic processing of software defined network and/or integrated services digital network voice alarms. In order to clearly describe the current invention, the following networking terminologies and concepts are first provided:

A switched network;

A class-4 central office;

A class-5 central office;

Class-4 Electronic Switching System (4ESS);

Class-5 Electronic Switching System (5ESS);

A Software Defined Network (SDN); and

Integrated Services Digital Network (ISDN).

A switched network refers to a network that interconnects class 4 and class 5 central offices as described below. The switching is accomplished by disconnecting and reconnecting lines in different configurations to enable a continuous pathway to be set up between a sender and a recipient.

A class-4 central office refers to a switching center for toll calls. A class 4 office, switches toll traffic originating at class 5 offices to other class 4 offices, or to offices of a higher class. A class 4 office also relays toll traffic from a class 4 toll office, to a class 5 office serving a destination address.

A class-5 central office refers to the lowest level in a hierarchy of central offices. A class 5 office serves as a network entry point for customer access lines. Class 5 central offices are also switching centers for local calls.

Class-4 Electronic Switching System (4ESS) refers to a switch used mainly in class 4 offices.

Class-5 Electronic Switching System (5ESS) refers to a switch used in class 5 offices, and sometimes in offices too small for class 4 switches.

A Software Defined Network (SDN) refers to a network that provides customers with a capability to have a Virtual Private Network (VPN) using the facilities of a service provider's network. For example, an SDN may be an enterprise customer's VPN that resides in a service provider's switched network (e.g., a 4ESS switch based network). The enterprise customer may then obtain network based features and management capabilities that are normally not found in a private network. For example an SDN may provide features such as customized routing, advance numbering plan, call screening, authorization code, remote access, security code, customized billing, etc.

Integrated Services Digital Network (ISDN) refers to a network that supports a customer's traffic with the flexibility to re-allocate capacity for any type of traffic, e.g., voice traffic, data traffic, video traffic. That is, any channel may carry any type of connection, eliminating the need for single-purpose trunks such as dedicated video trunks, dedicated data trunks, dedicated Direct Inward Dial (DID) trunks, dedicated Direct Outward Dial (DOD) trunks, and so on.

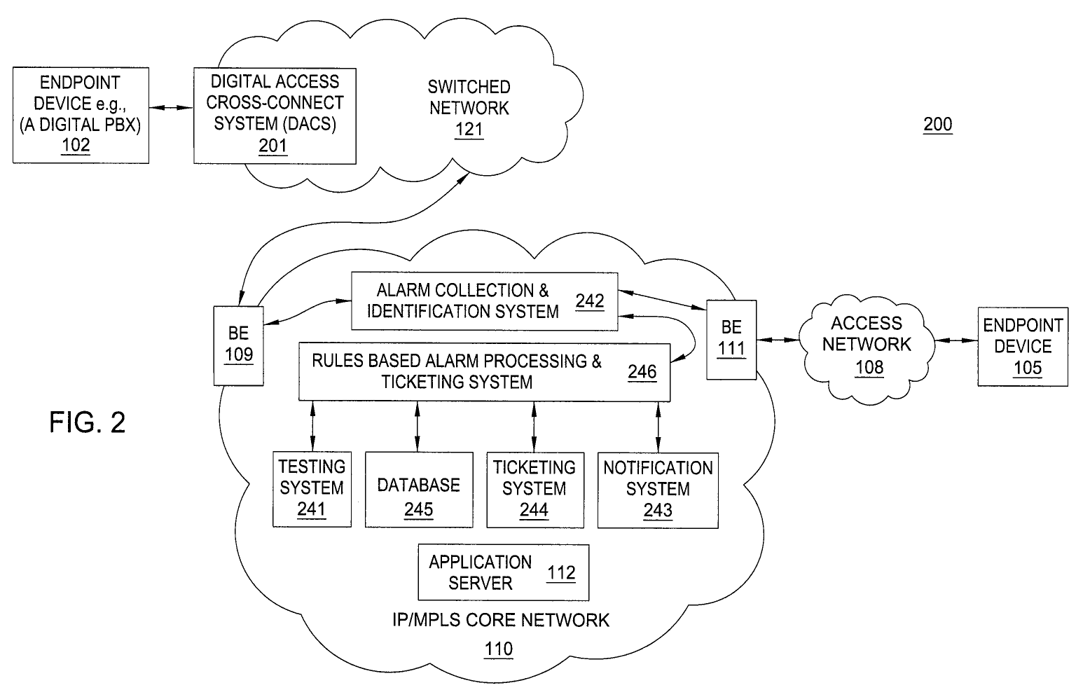

FIG. 2 illustrates an exemplary network 200 with automated processing of a software defined network and/or an integrated services digital network voice alarm. For example, an enterprise customer with endpoint device 102 is communicating with a switched network 121 via a Digital Access Cross-connect System (DACS) 201 located in the switched network 121. Another customer with an endpoint device 105 is communicating with an IP/MPLS core network 110 via an access network 108.

For example, the IP/MPLS core network 110 may comprise application server 112, border elements 109 and 111, a testing system 241, an alarm collection and identification system 242, a notification system 243, a ticket generation system 244, a database of record 245, and a rule based alarm processing and ticketing system 246.

In one embodiment, the DACS 201 is used to switch traffic between lines or between individual channels within a line, e.g., to switch traffic between 56 Kb/s channels within a 1.5 Mb/s channel. Border elements 109 and 111 function as PE routers for the IP/MPLS core network 110. The rule based alarm processing and ticketing system 246 is connected to the various systems 241-245 for automating processing of network alarms. The application server 112 enables customers to subscribe to services with automated processing of network alarms.

In one embodiment, the testing system 241 is used for sending test packets and receiving responses. For example, the testing system may send “ping” signal to ports on switches, get snapshots of various counters in routers and switches, and so on. The ticket generation system 244 is accessible by customers and service provider personnel. For example, a customer or work center personnel may interact with an Interactive Voice Response (IVR) system to generate a ticket. The ticket can also be created from automatically detected alarms by alarm collection and identification system 242. In one embodiment, the alarm collection and identification system 242 is connected to PE routers 109 and 111. Similarly, the notification system 243 may be used to provide a notification to a customer, or one or more work centers.

The enterprise customer using an endpoint device 102 to access a Software Defined Network (SDN) or an Integrated Services Digital Network (ISDN) may originate a call to a user with an endpoint device 105. That is, the calling party may subscribe to an SDN and/or ISDN service from the switched network 121, while the called party may subscribe to services from the IP/MPLS network 110, e.g., a Voice over Internet Protocol (VoIP) network.

In one embodiment, the current invention provides automatic processing of SDN and ISDN service alarms. In one example, an enterprise customer reports trouble to a service provider via an IVR system. For example, a customer reports trouble on a circuit ID being used for an SDN/ISDN service. The report/alarm may be forwarded to the service provider's rule based alarm processing and ticketing system 246. The rule based alarm processing and ticketing system 246 may then process the ticket/alarm in an automated fashion.

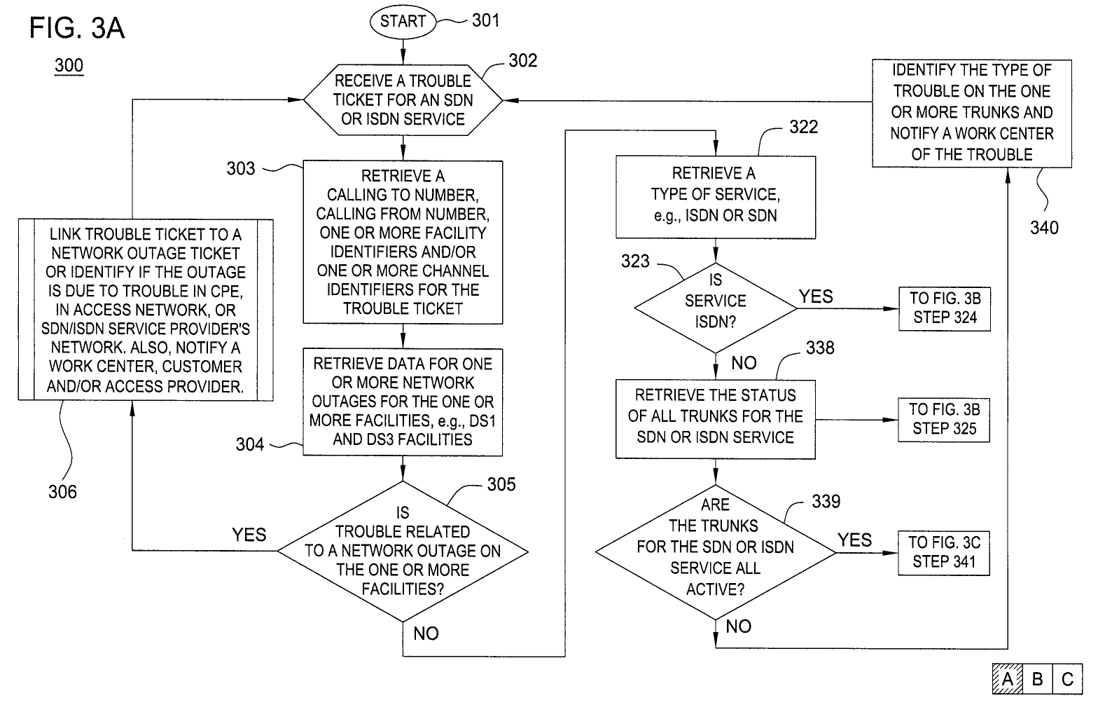

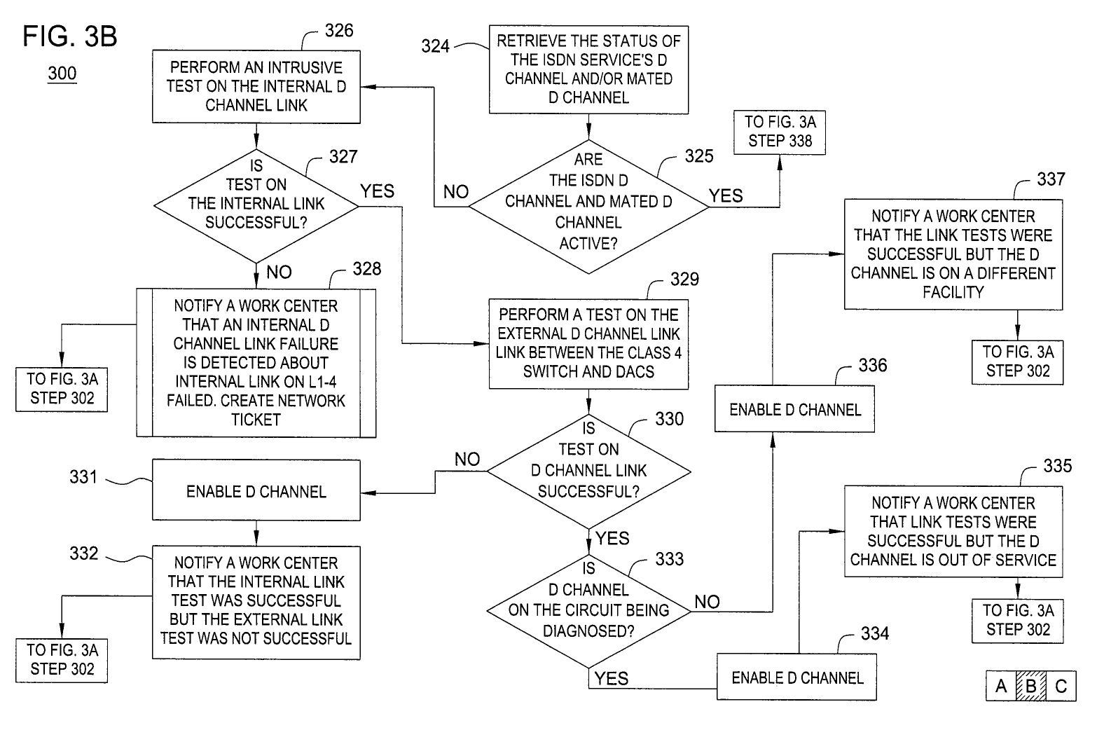

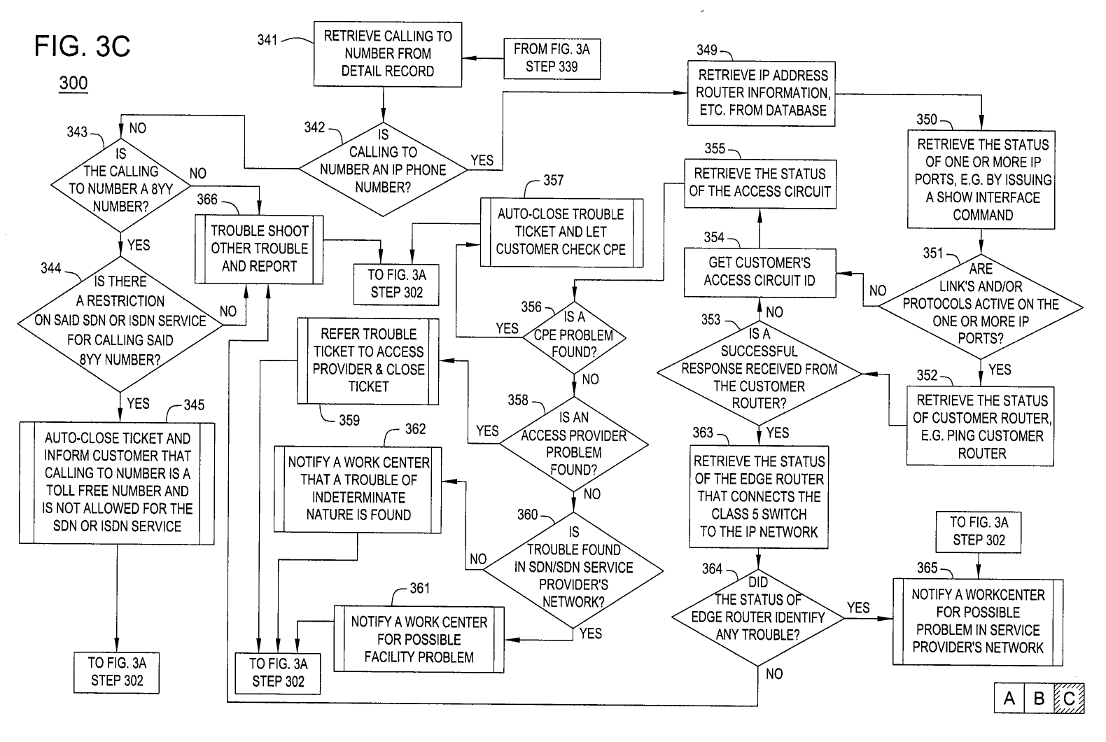

FIG. 3 provides a flowchart of a method 300 for processing of SDN and/or ISDN service alarms. For example, one or more steps of method 300 can be implemented by the rule based alarm processing and ticketing system 246. Method 300 starts in step 301 and proceeds to step 302.

In step 302, method 300 receives a trouble ticket for an SDN or ISDN service. For example, a customer reports trouble on a circuit and the method receives a ticket with a circuit ID.

In step 303, method 300 retrieves a calling to number, a calling from number, one or more facility identifiers and/or one or more channel identifiers for said trouble ticket. For example, the method retrieves the calling and called parties' phone numbers, the Digital Signaling level 0 (DS0) channel numbers, Common Language Facility Identifiers (CLFI) for Digital Signaling level 1 (DS1) and/or Digital Signaling level 3 (DS3) channels using the circuit ID and/or the ticket. CLFI refers to a standard based naming scheme for transmission facilities. A DS0 channel refers to a 64 Kb/s channel. A DS1 channel refers to a 1.544 Mb/s channel. A DS3 channel refers to a 44.736 Mb/s channel and so on.

Note that a DS1 channel may carry up to 24 DS0 channels and a DS3 channel may carry up to 672 DS0 channels. For example, for an ISDN service of 1.544 Mb/s, 23 of the DS0 channels may be used for voice and the 24^{th} channel may be used for data, e.g., a fax line. The channels used for voice may be referred to as B channels and the channels used for data may be referred to as D channels. The DS1 and DS3 channels containing several DS0 channels are also referred to facilities and may be reassigned to other traffic as needed. For example, a DS0 channel in a different DS1/DS3 may be used for control traffic. These channels are sometimes referred to as mated data channels (mated D channels), as described below.

In step 304, method 300 retrieves data for one or more network outages for the one or more facilities. For example, the method retrieves data for DS1 and/or DS3 facilities. The method then proceeds to step 305.

In step 305, method 300 determines if the trouble is related to a network outage on the one or more facilities. For example, the method determines if the trouble is due to a DS1 and/or DS3 facility trouble. If the trouble is due to the network outage, the method proceeds to step 306. If the trouble is not due to a network outage, the method proceeds to step 322.

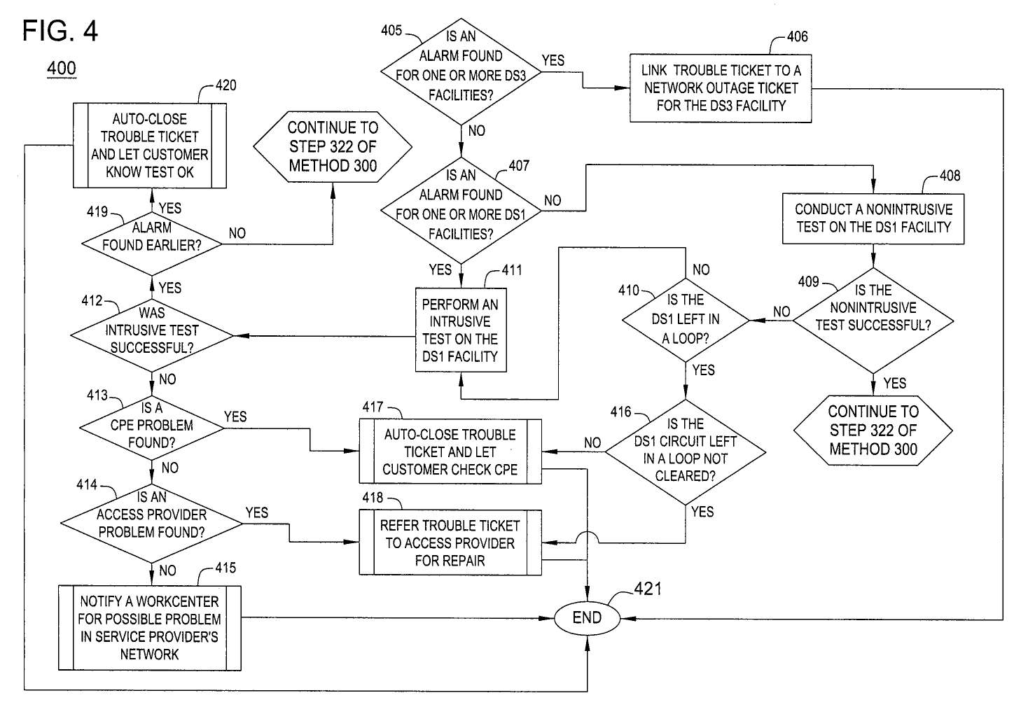

In step 306, method 300 either links the trouble ticket to a network outage ticket, identifies whether or not the outage is due to trouble in the customer premise equipment (CPE), in the access network, or the SDN/ISDN service provider's network. The method may then notify a work center, a customer and/or an access provider. The method then proceeds to step 302. FIG. 4 illustrates a flowchart of a method 400 as discussed below for implementing steps 305 and 306 to identify and report troubles related to network outages.

In step 322, method 300 retrieves a type of service. For example, the method may retrieve an indicator for an ISDN or SDN service. The method then proceeds to step 323.

In step 323, method 300 determines if the service is an ISDN service. If the service is ISDN, then the method proceeds to step 324. If the service is SDN, the method proceeds to step 338 to determine trunk status.

In step 324, method 300 retrieves the status of the ISDN service's D channel and/or mated D channel. “Mated D channel” refers to a D channel from another trunk that may be used for control of the current channel for ISDN service. The method then proceeds to step 325.

In step 325, method 300 determines if the D channel and/or mated D channel are active. If the D channel and/or mated D channel are active, the method proceeds to step 338 to determine trunk status. Otherwise, the method proceeds to step 326.

In step 326, method 300 performs an intrusive test on the internal D channel link in the class 4 switch (e.g. link in the 4ESS switch). The method then proceeds to step 327.

In step 327, method 300 determines if the intrusive test on the internal D channel link is successful. If the test is successful, the method proceeds to step 329. Otherwise, the method proceeds to step 328.

In step 328, method 300 notifies a work center that internal D channel link failure is detected. The method may also create a network ticket for the internal link failure. The method then proceeds to step 302.

In step 329, method 300 performs a test on the external D channel link between the class 4 switch and DACS. For example, the method may perform a loop test for the link between the 4ESS switch and DACS. The method then proceeds to step 330.

In step 330, method 300 determines if the test on the external D channel link is successful. If the test is successful, the method proceeds to step 333. Otherwise, the method proceeds to step 331.

In step 331, method 300 enables the D channel. For example, the D channel may have been out of service for maintenance. The method then proceeds to step 332.

In step 332, method 300 notifies a work center that the internal link test was successful and the external link test was not successful. The method may also create a network ticket for the failure of the external link. The method then proceeds to step 302.

In step 333, method 300 determines whether or not the D channel is on the circuit being diagnosed. For example, the D channel may be on the mated circuit on another trunk. If the D channel is on the circuit being diagnosed, the method proceeds to step 334. Otherwise, the method proceeds to step 336.

In step 334, method 300 enables the D channel. For example, the D channel may have been out of service for maintenance. The method then proceeds to step 335.

In step 335, method 300 notifies a work center that link tests were successful but the D channel is out of service. The method then proceeds to step 302.

In step 336, method 300 enables the D channel. For example, the D channel may have been out of service for maintenance. The method then proceeds to step 337.

In step 337, method 300 notifies a work center that link tests were successful but the D channel is on a different facility. Maintenance personnel may then continue troubleshooting. The method then proceeds to step 302.

In step 338, method 300 retrieves the status of all trunks for the SDN or ISDN service. For example, the method may retrieve the status of all trunks to determine if one or more trunks are disabled or locked out. Maintenance personnel or the system may disable or lockout a trunk. The method then proceeds to step 339.

In step 339, method 300 determines if the trunks for the SDN or ISDN service are all active. If all trunks are active, the method proceeds to step 341 to continue diagnosing the calling to number. Otherwise, the method proceeds to step 340.

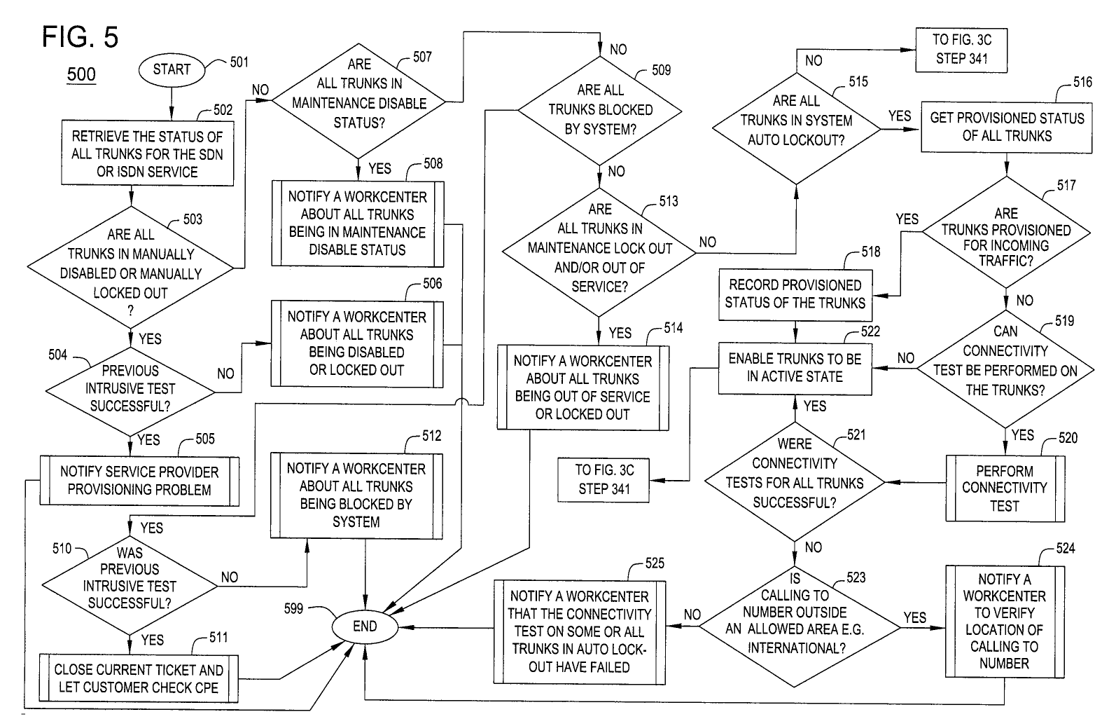

In step 340, method 300 identify the type of trouble on the one or more trunks and notify a work center of the trouble. For example, the method may determine that one or more trunks are locked out manually by maintenance personnel. The method then proceeds to step 302. FIG. 5 illustrates a flowchart of a method 500 as discussed below for implementing steps 338, 339 and 340 to determine the status of all trunks for the SDN or ISDN service and to notify a work center.

In step 341, method 300 retrieves the calling to number from a database containing Call Detail Records (CDR). The method then proceeds to step 342.

In step 342, method 300 determines whether or not the calling to number is an IP telephone number. For example, the called party may be a customer of VoIP service. If the calling to number is an IP telephone number, the method proceeds to step 349. Otherwise, the method proceeds to step 343.

In step 343, method 300 determines if the calling to number is an 8YY number, e.g., a toll-free number for incoming calls. If the calling to number is an 8YY number the method proceeds to step 344. Otherwise, the method proceeds to step 366.

In step 344, method 300 determines whether or not there is a restriction on said SDN or ISDN service for calling said 8YY number. For example, the SDN/ISDN customer may be allowed to call 8YY numbers only if the customer also subscribes to a digital link service. If there is a restriction on said SDN or ISDN service, the method proceeds to step 345. Otherwise, the method proceeds to step 366.

In step 345, method 300 notifies the customer that the calling to number is an 8YY number and a restriction on the SDN or ISDN service for calling 8YY numbers exists. The method then closes the current ticket and proceeds to step 302.

In step 349, method 300 retrieves the IP address, router information, etc. from a database. For example, the called party may subscribe to a Voice over Internet Protocol (VoIP) service. The method then retrieves the IP address, router information, etc. The method then proceeds to step 350.

In step 350, method 300 retrieves the status of one or more IP ports, e.g., by issuing a show interface command, and proceeds to step 351.

In step 351, method 300 determines whether or not the links and protocols are active on the one or more IP ports. For example, the method may run show interface command to ports on routers to obtain port and protocol status. If the links and protocols are not active, the method proceeds to step 354. Otherwise, the method proceeds to step 352.

In step 352, method 300 retrieves the status of the customer router, e.g., by sending a ping command to the customer router from the provider edge router. The method then proceeds to step 353.

In step 353, method 300 determines whether or not a successful response is received from the customer router. If a successful response is received from the customer router, the method proceeds to step 363. Otherwise, the method proceeds to step 354.

In step 354, method 300 retrieves the customer's access circuit ID. For example, the method may access a database for circuit IDs and retrieves the access circuit ID. The method then proceeds to step 355.

In step 355, method 300 retrieves the status of the access circuit. For example, the method may interact with a monitoring device for the access circuit and retrieves status information. The method then proceeds to step 356.

In step 356, method 300 determines if a Customer Premise Equipment (CPE) trouble is found. For example, the status of the access circuit may identify a CPE problem. If a CPE problem is found, the method proceeds to step 357. Otherwise, the method proceeds to step 358.

In step 357, method 300 notifies the customer to check his/her CPE device and closes the trouble ticket. The method then proceeds to step 302.

In step 358, method 300 determines if an access provider problem is found. For example, the status of the access circuit may identify a problem in the access provider's circuit. If an access provider problem is found, the method proceeds to step 359. Otherwise, the method proceeds to step 360.

In step 359, method 300 refers the trouble ticket to the access provider and closes the current trouble ticket. The method then proceeds to step 302.

In step 360, method 300 determines if a problem in the SDN or ISDN service provider's network is found. For example, a facility problem may be identified. If a problem in the SDN or ISDN service provider's network is found, the method proceeds to step 361. Otherwise, the method proceeds to step 362.

In step 361, method 300 notifies a work center that of a problem in the SDN or ISDN service provider's network. The method then proceeds to step 302. The service provider may continue trouble shooting.

In step 362, method 300 notifies a work center that a trouble of unknown nature is found. For example, the link and/or protocol may be inactive but there is no known problem in the CPE, access network and the service provider's network. The method then proceeds to step 302.

In step 363, method 300 retrieves the status of the edge router that connects the class 5 switch to the IP network. For example, the method may ping the edge router. The method then proceeds to step 364.

In step 364, method 300 determines whether or not the status of the edge router identified any trouble. If no trouble is identified, the method proceeds to step 366. Otherwise, the method proceeds to step 365.

In step 365, method 300 notifies the work center of possible problem in the service provider's network. A work center personnel may then initiate remedy steps. The method then proceeds to step 302.

In step 366, method 300 troubleshoots to identify other troubles and reports results to the service provider. The method then proceeds to step 302.

FIG. 4 illustrates a flowchart of a method 400 for implementing steps 305 and 306 of method 300 to identify and report troubles related to network outages.

In step 405, method 400 determines whether or not an alarm is found for one or more DS3 facilities. If an alarm is found, the method proceeds to step 406. Otherwise, the method proceeds to step 407.

In step 406, method 400 links the current trouble ticket to a network outage ticket for the DS3 facility. That is, the current trouble may be related to an outage on the DS3 channel. The method 400 then proceeds to step 421.

In step 407, method 400 determines whether or not an alarm is found for one or more DS1 facilities. If an alarm is found, the method proceeds to step 411. Otherwise, the method proceeds to step 408.

In step 408, method 400 conducts a non-intrusive test on the customer's DS1 facility. For example, the method may take readout of one or more monitoring units for Network Interface (NI) device, Channel Service Unit (CSU), DACS, etc. being used for the DS1. The method then proceeds to step 409.

In step 409, method 400 determines if the non-intrusive test was successful. If the non-intrusive test is successful, both the DS1 and DS3 facilities have no trouble and the method proceeds to step 322 of method 300 to continue with diagnosing the DS0 facilities. If the non-intrusive test is not successful, the method proceeds to step 410.

In step 410, method 400 determines if the DS1 circuit is left in a loop. For example, maintenance personnel may have been conducting a loopback test and may have left the DS1 facility in a loop. If a DS1 loop is found, the method proceeds to step 416. Otherwise, the method proceeds to step 411. In step 411, method 400 performs an intrusive test on the DS1 facility. For example, the method performs a Complete Auto Test (CAT) for said DS1 channel. In one embodiment, the CAT test is performed by building a loop to the CSU, NI, DACS, etc. sequentially to identify trouble at customer site, local access network, facility between access provider and SDN/ISDN service provider, respectively. For example, if a loopback is built to the CSU and the test fails, the trouble may be in the CSU. The method then proceeds to step 412.

In step 412, method 400 determines if the intrusive test is successful. If the intrusive test is successful, the method proceeds to step 419. Otherwise, the method proceeds to step 413.

In step 413, method 400 determines if a Customer Premise Equipment (CPE) trouble is found. For example, the intrusive test may have identified a CPE trouble. If a CPE trouble is found, the method proceeds to step 417. Otherwise, the method proceeds to step 414.

In step 414, method 400 determines if trouble is found in the access provider's network. If a trouble in access provider's network is found, the method proceeds to step 418. Otherwise, the method proceeds to step 415.

In step 415, method 400 notifies a work center of a possible trouble in the service provider's network. For example, the intrusive test has identified a network trouble and the trouble is not in the CPE or access provider's network. That means, the trouble may be in the SDN/ISDN service provider's network. The method 400 then proceeds to step 421.

In step 416, method 400 determines if the DS1 circuit left in a loop is not cleared. If the loop is not cleared, the method proceeds to step 418. Otherwise, the method proceeds to step 417.

In step 417, method 400 closes the trouble ticket and notifies the customer to check his/her CPE. For example, the intrusive test may have shown trouble is at the customer premise. The method 400 then proceeds to step 421.

In step 418, method 400 refers the trouble ticket to the access provider for repair. For example, the access provider may have left a loop up. The method 400 then proceeds to step 421.

In step 419, method 400 determines if an alarm was found previously. For example, the trouble may have cleared without requiring an action by the service provider. If an alarm was found previously, the method proceeds to step 420. Otherwise, the method proceeds to step 322 of method 300 to continue diagnosing the DS0 channels.

In step 420, method 400 notifies the customer that intrusive test was successful and closes the trouble ticket. The method 400 then proceeds to step 421.

Method 400 ends in step 421.

FIG. 5 illustrates a flowchart of a method 500 for implementing steps 338, 339 and 340 to determine the status of all trunks for the SDN or ISDN service and notify a work center. Method 500 starts in step 501 and proceeds to step 502.

In step 502, method 500 retrieves the status of all trunks for the SDN or ISDN service. For example, the method may retrieve trunk status from monitoring devices and/or switches for all trunks used for the SDN/ISDN service. The method then proceeds to step 503.

In step 503, method 500 determines whether or not all trunks are manually disabled or manually locked out. For example, some trunks may be manually disabled and some trunks may be manually locked out. If all trunks are manually disabled or manually locked out the method proceeds to step 504. Otherwise, method 500 proceeds to step 507.

In step 504, method 500 determines whether or not the previous intrusive test was successful. For example, the intrusive test of step 311 of method 300 might have been successful. If the previous intrusive test was successful, method 500 proceeds to step 505. Otherwise, the method proceeds to step 506.

In step 505, method 500 notifies the service provider of provisioning problem. The method then proceeds to step 599.

In step 506, method 500 notifies a work center that all trunks are manually disabled or locked out. The method then proceeds to step 599.

In step 507, method 500 determines if all trunks are in a maintenance disabled status. For example, maintenance personnel may have disabled all trunks. If all trunks are in a maintenance disabled status, method 500 proceeds to step 508. Otherwise, the method proceeds to step 509.

In step 508, method 500 notifies a work center that all trunks are disabled for maintenance. The method then proceeds to step 599.

In step 509, method 500 determines if all trunks are blocked by the system. For example, all trunks may be blocked automatically by the operating system. If all trunks are blocked by the system, the method proceeds to step 510. Otherwise, the method proceeds to step 513.

In step 510, method 500 determines whether or not the previous intrusive test was successful. For example, the intrusive test of step 311 of method 300 might have been successful. If the previous intrusive test was successful, method 500 proceeds to step 511. Otherwise, the method proceeds to step 512.

In step 511, method 500 notifies the customer to check his/her CPE device and closes the current ticket. The method then proceeds to step 599.

In step 512, method 500 notifies a work center that all trunks are blocked by the system. The method then proceeds to step 599.

In step 513, method 500 determines whether or not all trunks are in a maintenance lockout and/or out of service. If all trunks are in either a maintenance lockout or out of service status, the method proceeds to step 514. Otherwise, the method proceeds to step 515.

In step 514, method 500 notifies a work center that all trunks are either in a maintenance lockout and/or out of service. The method then proceeds to step 599.

In step 515, method 500 determines if all trunks are in system auto lockout. For example, the operating system may have automatically placed all trunks in a lockout status. If all trunks are in system auto lockout, the method proceeds to step 516. Otherwise, the method proceeds to step 341 of method 300 to continue troubleshooting calling to number.

In step 516, method 500 retrieves provisioned status of all trunks. For example, the method may determine a trunk is provisioned for either outgoing or incoming traffic. The method then proceeds to step 517.

In step 517, method 500 determines if the trunks are provisioned for incoming traffic. For example, the trouble may be due to said trunks being provisioned for incoming traffic only. If said trunks are provisioned for incoming traffic, the method proceeds to step 518. Otherwise, the method proceeds to step 519.

In step 518, method 500 records the provisioned status of the trunks and proceeds to step 522. For example, the provisioned status may indicate that all trunks are for incoming traffic.

In step 519, method 500 determines if connectivity test can be performed on the trunks. For example, the trunks may be provisioning for outgoing traffic and a test of connectivity may be performed. The test of connectivity may be a simple test similar to a ping test. If a connectivity test can be performed on the trunks, the method proceeds to step 520. Otherwise, the method proceeds to 522.

In step 520, method 500 performs the connectivity test on the trunks to identify network troubles. The method then proceeds to step 521.

In step 521, method 500 determines if the connectivity tests for all trunks were successful. For example, the connectivity test may identify a layer 1 problem as a possible cause for current trouble. If the connectivity tests are successful, the method proceeds to step 522. Otherwise, the method proceeds to step 523.

In step 522, method 500 enables the trunks to be in active state. For example, the method may override system lockouts. The method then proceeds to step 341 of method 300.

In step 523, method 500 determines if the calling to number is a number outside of an allowed area. For example, the call may have originated from an international location (outside the domestic area). If the calling to number is a number outside of an allowed area, the method proceeds to step 524. Otherwise, the method proceeds to step 525.

In step 524, method 500 notifies a work center to verify location of the calling to number. The method then proceeds to step 599.

In step 525, method 500 notifies a work center that the connectivity test on some or all trunks in system auto lockout have failed. The method then proceeds to step 599.

Method 500 ends in step 599.

It should be noted that although not specifically specified, one or more steps of methods 300, 400 and 500 may include a storing, displaying and/or outputting step as required for a particular application. In other words, any data, records, fields, and/or intermediate results discussed in the methods 300, 400 and 500 can be stored, displayed and/or outputted to another device as required for a particular application. Furthermore, steps or blocks in FIG. 3, FIG. 4 or FIG. 5 that recite a determining operation, or involve a decision, do not necessarily require that both branches of the determining operation be practiced. In other words, one of the branches of the determining operation can be deemed as an optional step.

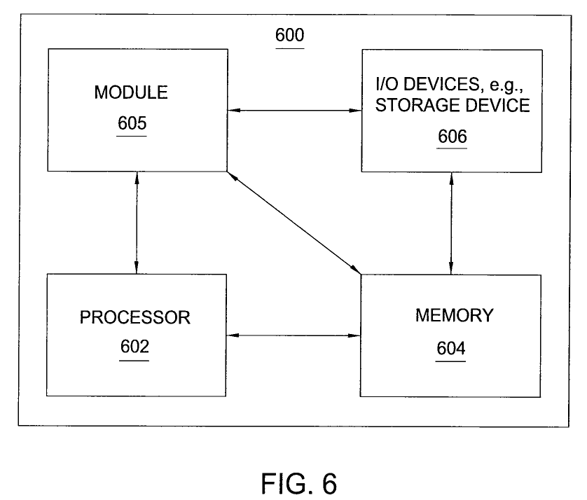

FIG. 6 depicts a high-level block diagram of a general-purpose computer suitable for use in performing the functions described herein. As depicted in FIG. 6, the system 600 comprises a processor element 602 (e.g., a CPU), a memory 604, e.g., random access memory (RAM) and/or read only memory (ROM), a module 605 for providing automatic processing of a network service alarm, and various input/output devices 606 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present module or process 605 for providing automatic processing of a network service alarm can be loaded into memory 604 and executed by processor 602 to implement the functions as discussed above. As such, the present method 605 for providing automatic processing of a network service alarm (including associated data structures) of the present invention can be stored on a computer readable medium, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for processing a Software Defined Network (SDN) alarm or an Integrated Services Digital Network (ISDN) alarm comprising:
receiving a trouble ticket for an SDN service or an ISDN service;
retrieving at least one of: a calling to number, a calling from number, one or more facility identifiers associated one or more facilities, or one or more channel identifiers related to said trouble ticket; and
retrieving data for one or more network outages for said one or more facilities.

2. The method of claim 1, further comprising:
determining if a trouble is related to a network outage on said one or more facilities; and
linking said trouble ticket to a network outage ticket, or identifying if said network outage is associated with a customer premise equipment (CPE), an access provider network, a SDN service provider network or an ISDN service provider network, if said trouble is due to said network outage.

3. The method of claim 2, further comprising:
notifying at least one of: a work center for said SDN service provider network or for said ISDN service provider network, a customer, or an access provider responsible for said network outage.

4. The method of claim 2, further comprising:
if said trouble ticket is associated with an ISDN service, determining if a D channel or a mated D channel for said ISDN service is active; and
determining a trunk status, if said D channel or said mated D channel is active.

5. The method of claim 4, further comprising:
performing one or more tests on one or more internal D channel links in one or more class 4 switches or one or more external D channel links between said one or more class 4 switches and one or more Digital Access Cross-connect Systems (DACS);
notifying a work center if one or more tests on said one or more internal D channel links or said external D channel links fail;
enabling said D channel if said one or more tests on said one more external D channel links fail;
determining if said D channel is on a different facility if said one or more tests on said one or more internal D channel links and external D channel links are successful; and
notifying a work center if said D channel is on a different facility.

6. The method of claim 2, further comprising:
if said trouble ticket is associated with a SDN service, determining a trunk status for said SDN service.

7. The method of claim 4, wherein said determining said trunk status comprises:
determining if one or more trunks for said ISDN service are active;
identifying a type of trouble on said one or more trunks and notifying a work center, if one or more trunks for said ISDN service are inactive; and
diagnosing the calling to number, if all of said one or more trunks are active.

8. The method of claim 7, wherein said diagnosing the calling to number comprises:
determining if said calling to number is an Internet Protocol (IP) telephone number.

9. The method of claim 8, further comprising:
retrieving a status of one or more IP ports if said calling to number is said IP telephone number;
determining if one or more links or protocols are active for said one or more IP ports; and
determining a status of a customer router if said one or more links or protocols are active.

10. The method of claim 9, further comprising:
determining a status of an edge router that connects a class 5 switch to an IP network if said customer router is active; and
notifying a work center responsible for said edge router if said trouble ticket is due to a trouble associated with said edge router.

11. The method of claim 9, further comprising:
determining if said trouble ticket is due to a trouble in said Customer Premise Equipment, in said access provider network, in said SDN service provider network or in said ISDN service provider network, if one or more of said customer router, link, or protocol are inactive.

12. The method of claim 11, further comprising:
notifying at least one of: a work center, an access provider, or a customer, if said trouble ticket is due to a trouble in said Customer Premise Equipment, in said access provider network, in said SDN service provider network or in said ISDN service provider network; and
notifying a SDN service provider or an ISDN service provider that a trouble of an unknown nature is found, if said trouble ticket is not due to a trouble in said Customer Premise Equipment, in said access provider network, in said SDN service provider network or in said ISDN service provider network.

13. The method of claim 8, further comprising:
determining if the calling to number is a toll free number, if said calling to number is not an IP telephone number;
determining if there is a restriction on said ISDN service for calling said toll free number, if said calling to number is said toll free number; and
notifying said customer that a restriction on said ISDN service for calling tool free numbers exists, if there is said restriction for calling tool free numbers on said ISDN service.

14. The method of claim 6, wherein said determining said trunk status comprises:
determining if one or more trunks for said SDN service are active;
identifying a type of trouble on said one or more trunks and notifying a work center, if one or more trunks for said SDN service are inactive; and
diagnosing the calling to number, if all of said one or more trunks are active.

15. The method of claim 14, wherein said diagnosing the calling to number comprises:
determining if said calling to number is an Internet Protocol (IP) telephone number.

16. The method of claim 15, further comprising:
retrieving a status of one or more IP ports if said calling to number is said IP telephone number;
determining if one or more links or protocols are active for said one or more IP ports; and
determining a status of a customer router if said one or more links or protocols are active.

17. The method of claim 16, further comprising:
determining a status of an edge router that connects a class 5 switch to an IP network if said customer router is active; and
notifying a work center responsible for said edge router if said trouble ticket is due to a trouble associated with said edge router.

18. The method of claim 16, further comprising:
determining if said trouble ticket is due to a trouble in said Customer Premise Equipment, in said access provider network, in said SDN service provider network or in said ISDN service provider network, if one or more of said customer router, link, or protocol are inactive.

19. A computer-readable medium having stored thereon a plurality of instructions, the plurality of instructions including instructions which, when executed by a processor, cause the processor to perform the steps of a method for processing a Software Defined Network (SDN) alarm or an Integrated Services Digital Network (ISDN) alarm, comprising:
receiving a trouble ticket for an SDN service or an ISDN service;
retrieving at least one of: a calling to number, a calling from number, one or more facility identifiers associated one or more facilities, or one or more channel identifiers related to said trouble ticket; and
retrieving data for one or more network outages for said one or more facilities.

20. An apparatus for processing a Software Defined Network (SDN) alarm or an Integrated Services Digital Network (ISDN) alarm, comprising:
means for receiving a trouble ticket for an SDN service or an ISDN service;
mean for retrieving at least one of: a calling to number, a calling from number, one or more facility identifiers associated one or more facilities, or one or more channel identifiers related to said trouble ticket; and
means for retrieving data for one or more network outages for said one or more facilities.
